(19) United States
(12) Patent Application Publication
(10) Pub. No.: US 2009/0198471 A1
(43) Pub. Date: Aug. 6, 2009

(54) Method and device of autonomous determination of angle of drift of the moving object

(76) Inventors: Michael Naumov, Givatayim (IL); George Naumov, Tel Aviv (IL)

Correspondence Address: Michael Naumov, 3 Hazor Street, Tel Aviv, 69016, IL

(21) Appl. No.: 12/077,865

(22) Filed: Mar. 24, 2008

(30) Foreign Application Priority Data
Feb. 5, 2008 (IL) 189284

(51) Int. Cl. G01C 1/00

(52) U.S. Cl. 702/151

(57) ABSTRACT

The present technical solution provided is intended for the accurate determination of angle of drift only by the means located inside the moving object, without applying any radiations and gyroscopes as well as without using any sources of information and orientation on the Earth and on any other heavenly bodies. The determination of such kind is provided for the first time and is considered to be of paramount importance for the navigational and meteorological purposes. The present solution is based on the determination of the horizontal projections of the linear acceleration vector by means of the sensors of said acceleration, they being developed by the authors earlier.

### FIELD OF THE INVENTION

The technical solution provided relates mainly to the navigation.

### BACKGROUND OF THE INVENTION

Angle of drift (Ψ) is considered to the angle in the horizontal plane between longitudinal

axis of the moving object and the direction of its ground speed vector W (the speed the relative to the Earth).

Said angle occurs, mainly, due to the influence of the wind on the aircraft and the water flow on the sea ship.

Knowing said angle is considered to allow one to determine the true course (α) [1], the direction of the movement of the object relative to the Earth (true ground angle β).

Under the autonomous determination in the present application we mean such determination thereof that is implemented only by the means located inside said moving object, without using any radiations (Doppler's, for instance), magnetic field of the Earth, any ground and heavenly sources of information as well as landmarks.

Said autonomous determination of the angle of drift has not been discovered by the authors in the prior art.

The technical solution provided has for its purpose to autonomously, accurately and quickly determine the angle of drift.

### SUMMARY OF THE INVENTION

To achieve the above purpose there is a method of autonomous determination of the angle of drift Ψ of the moving object, including the following mutually interconnected stages:
determination of the projection α_{ξ} of the linear vector acceleration of the moving object (i.e. the vector being at tangent to the trajectory of its movement) on the line of crossing ξ of the horizontal plane with the plane going through the vertical and longitudinal axes of said object, in particular, through the lines parallel to said axes,
determination of the projection α_{ζ} of said vector on the line of crossing ζ of the horizontal plane with the plane going through the vertical and transverse axes of said object, in particular, through the lines parallel to said axes,
determination of the angle of drift Ψ by means of said projections, in particular, by means of the technical implementation of the design formula

$$Ψ = arctg \frac{\int {a}_{ζ} d t}{\int {a}_{ξ} d t} , \qquad ( 1 )$$

α with α_{ξ}=const and α_{ζ}=const:

$$Ψ = arctg \frac{{a}_{ζ}}{{a}_{ξ}} \qquad ( 1 a )$$

two sensors (longitudinal and transverse) for the determination of said projections of the linear vector acceleration,
identifier said sensors are switched thereto, from the output thereof the signal of angle of drift being taken.

Each of said sensors of said projections [2] is based on the determination of the difference of total acceleration (the latter including linear acceleration and difference of centrifugal accelerations) and the difference of centrifugal accelerations.

In each of said sensors any harmful influence of the transverse (vertical and horizontal) and centrifugal (centripetal) accelerations is considered to be eliminated.

Coriolis accelerations can be ignored with higher accuracy since even for the aircrafts (planes) they are not expected to be higher than the least fractions of 1 m/sec².

Therefore, with higher accuracy it is possible to consider the values to be determined by said sensors α_{ξ} and α_{ζ} to be the projections of the linear acceleration vector onto the axes of crossing (ξ and ζ) of the horizontal plane with the planes going through the vertical axis of the moving object and, correspondingly, through the longitudinal and transverse axes of said object, in particular, through the lines parallel to said axes.

Moreover, in case of peculiar necessity this error (caused by Coriolis acceleration) can be taken into account by means of known mathematical formula. Since this very error is considered to be rather small, then for its determination it is possible to know an approximate speed of the moving object.

Knowing the angle of drift enables one to determine the true ground angle β

β=α+Ψ (2)

where
α—true course [1].

The true ground angle β is considered to determine the direction of the movement of the moving object relative to the Earth. Said direction is simultaneously considered to be the direction of the ground speed vector W, the value W thereof is obtained by the integration of the acceleration [symbol] in said direction [3]. By integrating the value of the speed W there is the distance traveled S obtained [3] relative to the Earth. By integrating the value of the projection α_{ζ} there is the wind speed (water flow) obtained, which is of significance not only for navigational but also for meteorological purposes.

### BRIEF DESCRIPTION OF THE INVENTION

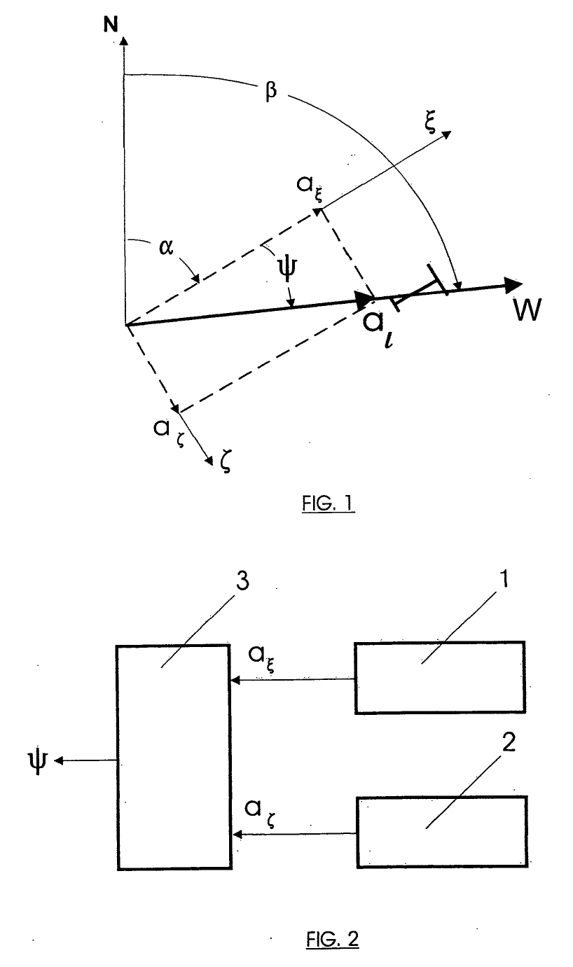

The present technical solution provided is illustrated by the accompanying drawings FIG. 1 and FIG. 2.

In FIG. 1 there are shown:
angle of drift Ψ which is determined by means of the projections α_{ξ} and α_{ζ} of the linear acceleration vector onto the horizontal lines of crossing ξ and ζ of said planes;
true course α [1] and true ground angle β to be determined by means of the angle of drift Ψ;
projection [symbol] of the linear acceleration vector onto the horizontal plane and the ground speed vector W.

In FIG. 1 by way of example there is shown α_{ξ}=const, α_{ζ}=const

In FIG. 2 there is shown a structural scheme of the determination of the angle of drift Ψ.

### DETAILED DESCRIPTION OF THE INVENTION

The present technical solution provided is based on the determination of the angle of drift Ψ (FIG. 1) by means of the projections α_{ξ} and α_{ζ} of the linear acceleration vector on the lines of crossing the horizontal plane with the planes going through the vertical axis of the moving object and, correspondingly, through the longitudinal and transverse axes of said object, in particular, through the lines parallel to said axes.

The device considered to implement the method provided (FIG. 2) comprises mutually interconnected:
sensor 1 [2] determining the projection α_{ξ} of the linear acceleration vector on the axis of crossing the horizontal plane with the plane going through the vertical and longitudinal axes of the moving object, in particular, through the lines parallel to said axes;
sensor 2 [2] determining the projection α_{ζ} of the linear acceleration vector on the axis of crossing the horizontal plane with the plane going through the vertical and transverse axes of the moving object, in particular, through the lines parallel to said axes;
identifier 3 said sensors are switched thereto.

Each of said sensors 1 and 2 is based on the determination of the difference of total acceleration (the latter including linear acceleration and difference of centrifugal accelerations) and the difference of centrifugal accelerations.

The vessels of the sensor 1 are fastened on the moving object so that the cross sections of the inner cavities of said vessels went through the vertical and longitudinal axes of said object, in particular, through the lines parallel to said axes.

The vessels of sensor 2 are fastened on the moving object so that the cross sections of the inner cavities of said vessels went through the vertical and transverse axes of said object, in particular, trough the lines parallel to said axes.

The signals sensors 1 and 2 (the signals of the projections α_{ξ} and α_{ζ}) are supplied to identifier 3, which can be fastened on the moving object in any convenient and appropriate place.

In said identifier 3 there is a signal of angle of drift Ψ determined, in particular, by means of the technical implementation of the design formula

$$Ψ = arctg \frac{\int {a}_{ζ} d t}{\int {a}_{ξ} d t} \qquad ( 1 )$$

α with α_{ξ}=const and α_{ζ}=const:

$$Ψ = arctg \frac{{a}_{ζ}}{{a}_{ξ}} \qquad ( 1 a )$$

This signal is taken from the output of said identifier.

Considerable distinguishing features of the solution provided:
for the time there is a solution provided of autonomous determination of angle of drift;
for the time for the determination of angle of drift there are horizontal projections of the linear acceleration vector applied.

The advantages of the solution provided.
autonomous determination of angle of drift,
the opportunity of applying for determining the true course [1],
the opportunity of autonomous determining of the ground speed vector,
the opportunity of determining angle of drift without the necessity of applying gyroscopes,
accurate, fast and non-stop determination of angle of drift.

We claim:

1. The method of the autonomous determination of angle of drift of the moving object comprising the following stages mutually being interconnected:
determining the projection of the linear acceleration vector of the moving object onto the line of crossing the horizontal plane with the plane going through the vertical and longitudinal axes of said object, in particular, through the lines parallel to said axes,
determining the projection of the linear acceleration vector of the moving object onto the line of crossing the horizontal plane with the plane going through the vertical and transverse axes of said object, in particular, through the lines parallel to said axes,
determining the angle of shift by means of said projections.

2. The method, as set forth in claim 1, wherein said angle of drift of the moving object being determined by means of the technical implementation of design formula
$$Ψ = arctg \frac{\int {a}_{ζ} d t}{\int {a}_{ξ} d t}$$
where
Ψ—angle of drift,
α_{ξ} and α_{ζ}—the projection of the linear acceleration vector of the moving object onto the line of crossing the horizontal plane with the planes going through the vertical axis of the moving object and, correspondingly, through its transverse and longitudinal axes, in particular, through the lines parallel to said axes,

3. The device for the autonomous determination of angle of drift of the moving object comprising mutually interconnected:
sensor determining the projection of the linear acceleration vector onto the line of crossing the horizontal plane with the plane going through the vertical and longitudinal axes of said object, in particular, through the lines parallel to said axes,
sensor determining the projection of the linear acceleration vector onto the line of crossing the horizontal plane with the plane going through the vertical and transverse axes of said object, in particular, through the lines parallel to said axes,
identifier, whereto the signal of said sensor being supplied, and wherefrom the signal of angle of drift being taken.

4. The device, as set forth in claim 3, wherein the vessels of said sensors being fastened on the moving object so that the cross-sections of the inner cavities of said vessels comprising the vertical axis of said object and, correspondingly, its transverse and longitudinal axes, in particular, the lines parallel to said axes.
